(19) United States
(12) Patent Application Publication
(10) Pub. No.: US 2013/0054676 A1
(43) Pub. Date: Feb. 28, 2013

(54) COMPUTER NETWORK BASED HAZARDOUS CONDITION MONITORING SYSTEM AND SERVER

(71) Applicants: SHIH-CHENG WANG, Tu-Cheng (TW); CHIEN-LIN CHEN, Tu-Cheng (TW)

(72) Inventors: SHIH-CHENG WANG, Tu-Cheng (TW); CHIEN-LIN CHEN, Tu-Cheng (TW)

(73) Assignee: HON HAI PRECISION INDUSTRY CO., LTD., Tu-Cheng (TW)

(21) Appl. No.: 13/219,726

(22) Filed: Aug. 29, 2011

(51) Int. Cl. G06F 15/16

(52) U.S. Cl. 709/203

(57) ABSTRACT

A hazardous condition monitoring system is provided. The hazardous condition monitoring system includes a server module, an interface adapting module, and a hazard processing module communicating with terminal devices. The server module includes a network interface unit and a processing unit. The interface adapting module communicates with the server module through the network interface unit through a computer network. The processing unit derives the output information from a second type signal received from the interface adapting module, and produces the second type signal including input information for the hazard processing module. The interface adaptor transforms a first type signal and the second type signal into the signal of the other type, and transmits the transformed signals to the server module and the hazard processing module, respectively. The disclosure further provides a server for monitoring hazardous conditions.

### BACKGROUND

1. Technical Field

The present disclosure relates to a hazardous condition monitoring system and a server for monitoring hazardous conditions, and particularly to a fire alarm monitoring system and a server for monitoring fire alarms.

2. Description of Related Art

In a conventional fire alarm system with many control panels, the control panels are coupled to a monitor, thereby monitoring the control panels and terminal devices such as thermal sensors or buzzers which are coupled to terminal devices. RS-232 interfaces which commonly used in computer serial ports are usually utilized as the interface for the transmission of the signals between the monitor and the control panels. When utilizing a server as the monitor, an interface adapter is needed. FIG. 1 is a block diagram of a conventional Ethernet based hazardous condition monitoring system. As shown in FIG. 1, a conventional hazardous condition monitoring system includes a server 1, interface adapters 2, control panels 3, and terminal devices 4 coupled to the control panels 3, wherein the server 1 is coupled to the interface adapters 2 through an Ethernet network 5. Each of the interface adapters 2 includes a deriving unit corresponding to the control panel 3 coupled to the interface adapters 2, which derives the status of the control panel 3 and/or the terminal devices 4 from the signals received from the control panels 3, and produces signals including control instructions for the control panel 3 and/or the terminal devices 4. In addition, each of the interface adapters 2 includes an RS-232 interface and an Ethernet interface for coupling to the control panel 3 and the server 1, respectively, thereby transforming signals transferred between the server 1 and the control panels 3 to adapt to the corresponding interfaces.

However, since the signals transferred between the server 1 and the control panels 3 have to be transformed by the deriving unit corresponding to the control panels 3, the interface adapters 2 are specified for the control panels 3 coupled thereto, so that a general interface adapter cannot be used. In addition, the design of the interface adapters 2 is relatively complex, which also increases the cost of the interface adapters 2. Thus, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of a conventional Ethernet based hazardous condition monitoring system.

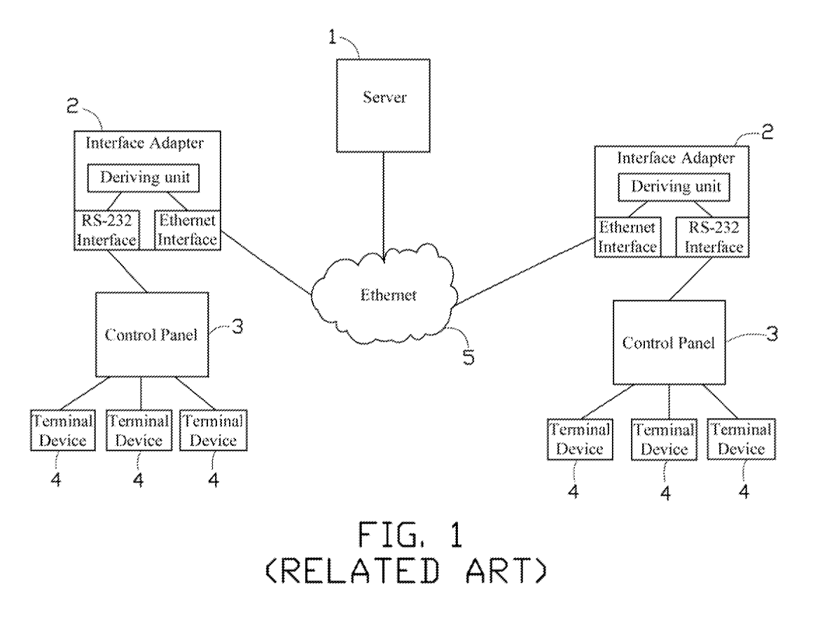

FIG. 2 is a block diagram of an embodiment of a hazardous condition monitoring system of the present disclosure.

FIG. 3 is a block diagram of another embodiment of a hazardous condition monitoring system of the present disclosure.

### DETAILED DESCRIPTION

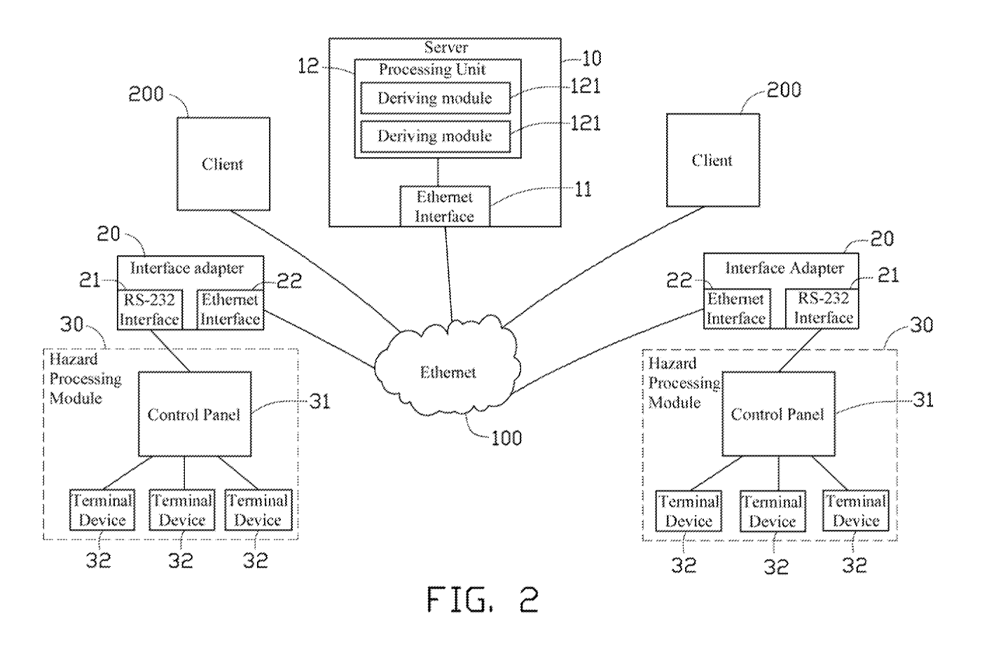

FIG. 2 is a block diagram of an embodiment of a hazardous condition monitoring system of the present disclosure. As shown in FIG. 2, a hazardous condition monitoring system includes a server 10, an interface adaptor 20, a hazard processing modules 30, an Ethernet network 100, and clients 200. The server 10 and the hazard processing modules 30 communicate with each other through the interface adaptor 20. In this embodiment, the hazardous condition monitoring system is utilized to ensure fire safety. In other embodiments, the hazardous condition monitoring system can be utilized in other types of monitoring such as security.

The server 10 includes an Ethernet interface 11 and a processing unit 12. In this embodiment, the server 10 is utilized to monitor fire alarms. In other embodiments, the server 10 can be utilized to monitor other types of alarms such as security alarms. The processing unit 12 includes deriving modules 121 for deriving output information Iₒ (not shown) from an Ethernet signal S_{E} (not shown) which is received from the interface adaptor 20, and produces the Ethernet signal S_{E} including input information Iᵢ (not shown) for the hazard processing module 30. The client 200 is connected to the server 10 through an Ethernet network 100, such that the client 200 can obtain the status information of the hazard processing module 30 by receiving the output information Iₒ of the hazard processing module 30 from the server 10 and control the hazard processing module 30 by transmitting the input information Iᵢ for the hazard processing module 30 to the server 10. In this embodiment, the server 10 and the client 200 include a display interface and an input interface for displaying the output information Iₒ received from the hazard processing modules 30 and input the input information Iᵢ for the hazard processing modules 30, respectively. In addition, the client 200 has a hazardous condition monitoring application program for communicating with the server 10, while the server 10 is capable of automatically updating the application program on the client 200. Through the server 10 and the client 200, the hazard processing module 30 can be remotely monitored.

Each of the interface adapters 20 includes an RS-232 interface 21 and an Ethernet interface 22. The Ethernet interface 22 is coupled to the Ethernet interface 11 of the server 10 through the Ethernet network 100. In this embodiment, the interface adapter 20 communicates with the Ethernet interface 11 of the server 10 through the Ethernet interface 22, and communicates with the hazard processing module 30 through the RS-232 interface 21. In other embodiments, the interface adapter 20 can communicate with the server 10 through other types of computer network interfaces such as wireless local area network (WLAN) interface and communicate with the hazard processing module 30 through other types of serial communication interfaces such as RS-485, or other types of data communication interfaces such as parallel communication interface. In addition, in this embodiment, the Ethernet interface 22 and the Ethernet interface 11 of the server 10 are coupled to each other through routers and/or switches to be in individual sub-networks. In other embodiments, the Ethernet interface 22 and the Ethernet interface 11 of the server 10 can be in the same sub-network. When receiving the RS-232 signal S_{S} including the output information Iₒ of the hazard processing module 30 from the hazard processing module 30, the interface adaptor 20 transforms the RS-232 signal S_{S} into the Ethernet signal S_{E}, and transmits the Ethernet signal S_{E} to the server 10 through the Ethernet interface 22. When receiving the Ethernet signal S_{E} including the input information Iᵢ for the hazard processing module 30, the interface adaptor 20 transforms the Ethernet signal S_{E} into the RS-232 signal S_{S}, and transmits the RS-232 signal S_{S} to the hazard processing module 30 through the RS-232 interface 21.

Each of the hazard processing modules 30 includes a control panel 31 and terminal devices 32. The deriving modules 121 of the processing unit 12 of the server 10 correspond to the control panel 31 of the hazard processing modules 30, respectively. The control panel 31 is coupled to the RS-232 interface 21 of the interface adapter 20. The terminal devices 32 can be electronic devices such as sensors, alarms, fire extinguishers, and controllers, which are responsive to fire safety related conditions and capable of sending out warnings. In this embodiment, the terminal devices 32 include thermal sensors, smoke sensors, buzzers, or other control panels. In other embodiments, the terminal devices 32 may include photoelectric sensors, acoustic sensors, tactile sensors, vibration sensors, and caution lights. When receiving the report signal S_{R} from the terminal device 32, the control panel 31 transmits the RS-232 signal S_{S} including the output information Iₒ corresponding to the report signal S_{R} to the interface adaptor 20. When receiving the RS-232 signal S_{S} from the interface adaptor 20, the control panel 31 transmits the control signal S_{c} corresponding to the input information Iᵢ of the RS-232 signal S_{S} to the terminal device 32. In this embodiment, the output information Iₒ includes status information of the control panel 31 and/or the terminal devices 32, such that the server 10 can derive the status, for example, activated/inactivated status or enabled/disabled status, of the control panel 31 and/or the terminal devices 32 in the status information. The input information Iᵢ includes a control instruction for the control panel 31 and/or the terminal devices 32, such that the server 10 and the client 200 can control, for example, activate/inactivate or enable/disable, the control panel 31 and/or the terminal devices 32 through the control instruction. In this embodiment, the server 10 periodically tests the control panel 31 and/or terminal devices 32 by sending the control instruction and receiving the status information corresponding to the control instruction.

In this embodiment, the control panels 31 are different types of control panels, which have individual status information format and individual control instruction format. Since the server 10 has the deriving modules 121 each corresponds to each of the control panels 31, the server 10 can recognize the status of the control panels 31 and/or the terminal devices 32, while the status information of the control panels 31 have different formats. And the server 10 can control the control panels 31 and/or the terminal devices 32, while the control instructions of the control panels 31 have different formats. Operation of the disclosed hazardous condition monitoring system is described through the following example.

When an event such as smoke or a control signal from other control panel is detected by one of the terminal devices 32 of one of the hazard processing modules 30, the terminal devices 32 transmits the report signal S_{R} corresponding to the event to the control panel 31. The control panel 31 transmits the RS-232 signal S_{S} including the output information Iₒ corresponding to the report signal S_{R} to the interface adapter 20 via a cable with D-sub connectors through the RS-232 interface 21. The interface adaptor 20 transforms the RS-232 signal S_{S} into the Ethernet signal S_{E}, and transmits the Ethernet signal S_{E} to the Ethernet network 100 via a Cat 5 cable with RJ45 connectors through the Ethernet interface 22. The server 10 receives the Ethernet signal S_{E} through the Ethernet interface 11 corresponding to the interface adapter 20, and derives the output information Iₒ from the Ethernet signal S_{E} through the deriving modules 121 of the processing unit 12, which correspond to the control panel 31. The status information in the output information Iₒ is displayed through the display interface of the server 10 in a formatted manner, thereby showing the event to the user of the server 10.

In response to the event, the server 10 produces a control instruction for the control panel 31 of the hazard processing module 30 which corresponds to the event automatically or through the input interface of the server 10. The deriving module 121 of the processing unit 12 which corresponding to the control panel 31 produces the Ethernet signal S_{E} including the input information Iᵢ, wherein the input information Iᵢ includes the control instructions for the control panels 31. The Ethernet signal S_{E} is transmitted to the Ethernet network 100 through the Ethernet interface 11. The interface adaptor 20 transforms the Ethernet signal S_{E} into the RS-232 signal S_{S}, and transmits the RS-232 signal S_{S} to the hazard processing module 30. The control panel 31 of the hazard processing module 30 transmits the control signal S_{C} corresponding to the input information Iᵢ of the RS-232 signal S_{S} to the terminal devices 32 near to the event, thereby enabling the terminal devices 32 to warn the people nearby.

The disclosed hazardous condition monitoring system utilizes the server 10 including the deriving modules 121 corresponding to the control panel 31 of the hazard processing modules 30 to achieve the communication between the server 10 and different types of the control panels 31 while using the interface adapter 20 not specified to the control panel 31. Consequently, different types of control panels can be integrated into the hazardous condition monitoring system by simply installing the deriving modules 121 corresponding to the control panels in the server 10, instead of using interface adapters specified for the control panels which have a deriving unit corresponding to the control panel. In addition, since a general interface adapter can be used as the interface adapter 20, the design of the interface adapters 2 is therefore relatively simple, which also decreases the cost of the interface adapters 2.

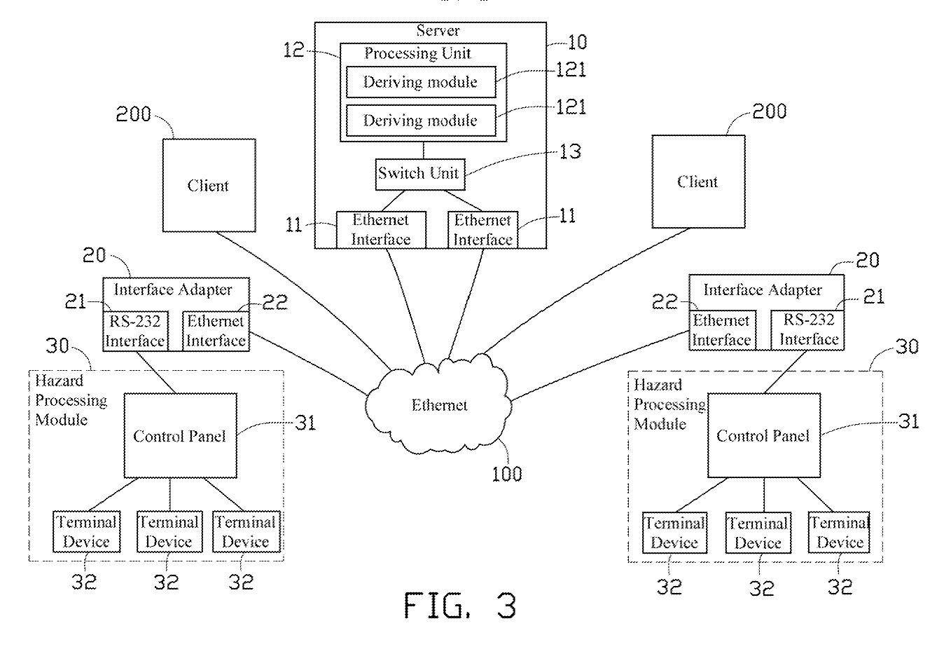

FIG. 3 is a block diagram of another embodiment of a hazardous condition monitoring system of the present disclosure. As shown in FIG. 3, in comparison with the embodiment of FIG. 2, the hazardous condition monitoring system includes a plurality of network interfaces 11 and further includes a switch 13. In addition, the server 10 periodically checks the effectiveness of the communication with respect to the interface adaptor 20. In this embodiment, each of the network interfaces 11 corresponds to an individual sub-network of the Ethernet network 100. The switch 13 enables one of the network interfaces 11 to communicate with the corresponding hazard processing module 30 through the interface adaptor 20 corresponding to the enabled network interface 11. When the communication between the enabled network interface 11 and the corresponding hazard processing module 30 has failed, for instance, the interface adaptor 20 corresponding to the enabled network interface 11 does not work, the switch 13 enables the other network interface 11 to communicate with the corresponding hazard processing module 30 through the interface adaptor 20 corresponding to the other network interface 11. Consequently, with the redundant communication interfaces, the communication between the server 10 and the hazard processing module 30 is therefore ensured. In other embodiments, the switch 13 can be omitted such that the server 10 communicates with the corresponding hazard processing module 30 directly through the network interfaces 11. Accordingly, other methods can be used to process the redundant signals from the network interfaces 11.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A hazardous condition monitoring system, comprising:
at least one hazard processing module configured to communicate with at least one terminal device;
a server module including a network interface unit and a processing unit; and
an interface adapting module configured to communicate with the network interface unit of the server module through a computer network, wherein the interface adapting module transforms a first type signal including an output information of the hazard processing module received from the hazard processing module into a second type signal and transmits the second type signal to the server module, and transforms the second type signal including an input information for the hazard processing module received from the server module into the first type signal and transmits the first type signal to the hazard processing module;
wherein the processing unit of the server module derives the output information from the second type signal, and produces the second type signal including the input information for the hazard processing module; the hazard processing module transmits the first type signal to the interface adapting module in response to a report signal received from the terminal device, and transmits a control signal to the terminal device in response to the first type signal received from the interface adapting module.

2. The system of claim 1, wherein the network interface unit is an Ethernet interface.

3. The system of claim 1, wherein the interface adapting module communicates with the hazard processing module through a serial communication interface.

4. The system of claim 3, wherein the serial communication interface is an RS-232 interface.

5. The system of claim 1, further comprising a client module, wherein the client module communicates with the server module through the computer network, the client module receives the output information of the hazard processing module from the server module through the computer network.

6. The system of claim 1, further comprising a client module, wherein the client module communicates with the server module through the computer network, the client module transmits the input information for the hazard processing module to the server module through the computer network.

7. The system of claim 1, wherein the server module includes a plurality of the network interface unit and further includes a switch unit, the switch unit enables one of the network interface units to communicate with the hazard processing module through the interface adapting module corresponding to the enabled network interface unit, and enables another of the network interface units to communicate with the hazard processing module through the interface adapting module corresponding to the network interface unit when the communication between the enabled network interface unit and the hazard processing module is failed.

8. The system of claim 7, wherein each of the network interface units corresponds to an individual sub-network of the computer network.

9. The system of claim 1, wherein the output information of the hazard processing module includes a status information of the hazard processing module and/or the terminal device, the input information for the hazard processing module includes a control instruction for the hazard processing module and/or the terminal device.

10. A server for monitoring hazardous condition, comprising:
a network interface unit configured to communicate with an interface adaptor through a computer network, wherein the interface adaptor is capable of transforming a first type signal including an output information of at least one hazard processing system received from the hazard processing system into a second type signal and transmitting the second type signal to the network interface unit, and transforming the second type signal including an input information for the hazard processing system received from the network interface unit into the first type signal and transmitting the first type signal to the hazard processing system; and
a processing unit deriving the output information from the second type signal, and producing the second type signal including the input information for the hazard processing system.

11. The server of claim 10, wherein the network interface unit is an Ethernet interface.

12. The server of claim 10, wherein the network interface unit is configured to communicate with the interface adaptor communicating with the hazard processing system through a serial communication interface.

13. The server of claim 12, wherein the network interface unit is configured to communicate with the interface adaptor communicating with the hazard processing system through an RS-232 interface.

14. The server of claim 10, further comprising a client unit, wherein the client unit communicates with the network interface through the computer network, the client unit receives the output information of the hazard processing system through the computer network.

15. The server of claim 10, further comprising a client unit, wherein the client unit communicates with the network interface through the computer network, the client unit transmits the input information for the hazard processing system to the processing unit through the computer network.

16. The server of claim 10, comprising a plurality of the network interface unit and further comprising a switch unit, wherein the switch unit enables one of the network interface units to communicate with the hazard processing system through the interface adapting module corresponding to the enabled network interface unit, and enables another of the network interface units to communicate with the hazard processing system through the interface adapting module corresponding to the network interface unit when the communication between the enabled network interface unit and the hazard processing system is failed.

17. The server of claim 16, wherein each of the network interface units corresponds to an individual sub-network of the computer network.

18. The server of claim 10, wherein network interface unit is configured to communicate with the interface adaptor communicating with the hazard processing system including a hazard processor and a terminal device, the hazard processor transmits the first type signal to the interface adapting module in response to a report signal received from the terminal device, and transmits a control signal to the terminal device in response to the first type signal received from the interface adapting module.

19. The server of claim 10, wherein the output information of the hazard processing module includes a status information of the hazard processing module and/or the terminal device.

20. The server of claim 10, wherein the input information for the hazard processing module includes a control instruction for the hazard processing module and/or the terminal device.
